(19) United States
(12) Patent Application Publication
(10) Pub. No.: US 2007/0231063 A1
(43) Pub. Date: Oct. 4, 2007

(54) Master Plate and Tool Plate for Robot Arm Coupling Apparatus, and Robot Arm Coupling Apparatus

(76) Inventors: Mikio Tsutsumi, Hyogo (JP); Yuichi Takahama, Hyogo (JP)

Correspondence Address: Nixon Peabody, 401 9th Street, N.W., Suite 900, Washington, DC, 20004-2128, US

(21) Appl. No.: 11/596,863

(22) PCT Filed: May 18, 2004
(86) PCT No.: PCT/JP04/07071

§ 371 Date: Nov. 17, 2006

(51) Int. Cl. B25G 3/18; B25J 15/04

(52) U.S. Cl. 403/322.2; 901/27

(57) ABSTRACT

The present invention is directed to a robot arm coupling apparatus comprising a master plate 1 attached to a robot arm, a tool plate 2 to which a tool or like element is attachable and a locking mechanism 27 for jointing and locking both the plates 1 and 2 together, and has an object of making the robot arm coupling apparatus thinner while employing ball members 44. To attain this, the outer periphery of a cam member 28 of the locking mechanism 27 has a plurality of master side ball receiving grooves 29 of substantially arcuate cross section formed to extend substantially along the sliding direction of the cam member 28 and each capable of receiving the corresponding ball member 44, a ball retainer 58 of the tool plate 2 has a plurality of tool side ball receiving grooves 63 of substantially arcuate cross section formed to extend substantially along the sliding direction of the cam member 28 and each capable of receiving the corresponding ball member 44, the inner surface of each master side ball receiving groove 29 is provided with a master side first inclined portion 30, the inner surface of each tool side receiving groove 63 is provided with a tool side inclined portion 64 inclined opposite to the master side first inclined portion 30. The apparatus is configured so that when the cam member 28 is positioned in the locking position, each master side first inclined portion 30 pushes the corresponding ball member 44 against the corresponding tool side inclined portion 64.

### TECHNICAL FIELD

This invention relates to a master plate and a tool plate for a robot arm coupling apparatus and a robot arm coupling apparatus formed of a combination of them.

### BACKGROUND ART

Coupling apparatuses for connecting and disconnecting a tool or like element to and from a robot arm include generally known coupling apparatuses comprising a master plate (inner assembly) attached to the robot arm, a tool plate (outer assembly) to which the tool or like element is attachable and a locking device for connecting and locking both the plates to each other.

One of conventional coupling apparatuses of such kind is a coupling apparatus capable of quickly connecting and disconnecting the inner assembly to and from the outer assembly. For example, as disclosed in the specification and drawings of U.S. Pat. No. 4,696,524, there is known a coupling apparatus in which the locking device comprises: a piston member supported by the inner assembly slidably between a locking position and an unlocking position; a plurality of ball members arranged around the piston member and supported to the inner assembly; and a ball retainer disposed in the outer assembly, contactable at the tapered surface with the ball members and holding both the plates connected to each other in cooperation with the ball members when the piston member moves to the locking position. According to this apparatus, when the piston member moves to the locking position, the ball members push up the outer assembly through the tapered surface of the ball retainer, thereby connecting the inner assembly to the outer assembly.

In the above conventional coupling apparatus, however, a portion of the piston member making contact with the ball members when the piston member is in the locking position is its cylindrical surface extending in parallel with the a sliding direction of the piston member and, therefore, processing irregularities in the inner assembly or the outer assembly would prevent the ball members from fully moving to the locking position. This presents the possibility that in connecting the inner assembly to the outer assembly, their connecting surfaces do not mate with each other, which provides a poor reproducibility of the connecting position.

To solve the above problem, as disclosed in Published Japanese Patent Application No. H04-63688, a technique is proposed in which a locking device for joining and locking the master plate and the tool plate together comprises: a disc-shaped cam member supported to the master plate slidably between a locking position and an unlocking position; a plurality of ball members arranged around the cam member and supported to the master plate for movement substantially orthogonal to a sliding direction of the cam member; and a ring-shaped ball retainer engaging with the ball members to connect both the plates to each other and hold them connected when the cam member moves to the locking position, the outer periphery of the cam member and the inner periphery of the ball retainer are formed with a master side tapered surface (cam surface) and a tool side tapered surface (cam surface) inclined opposite to the master side tapered surface, respectively, and the master side tapered surface pushes the ball members against the tool side tapered surface with the cam member in the locking position to prevent a gap from being created between the connecting surfaces of both the master plate and the tool plate during connection between both the plates, thereby improving the reproducibility of the connecting position.

For robot arm coupling apparatuses of this kind, there has been a recent demand to reduce the thickness (size) of connected master and tool plates along the connecting direction for the following itemized reasons.

(1) First, when a robot handles a work to move it from one pressing machine to another, for example, in a pressing process on a vehicle production line, the robot inserts a coupling apparatus, together with the work and a holder for the work, in between opened die halves of the pressing machine for the purpose of loading and unloading of the work onto and from the pressing machine. In this case, since the opening stroke of the die is limited, the robot arm coupling apparatus needs to have a thickness as thin as possible.

(2) In a structure in which a coupling apparatus is fitted between a wrist flange of a robot and a hand thereof for gripping a work, if the distance from the flange to the gravity center of the hand is long, the load (moment) on the robot becomes larger accordingly. In order to reduce the load, it is needed to reduce the thickness of the coupling apparatus to shorten the distance from the flange to the gravity center of the hand as much as possible.

(3) Furthermore, in the structure in which a coupling apparatus is fitted between a wrist flange of a robot and a had thereof for gripping a work, a thick coupling apparatus would cause the creation of an area in which the robot is difficult to work or cannot work. In order to reduce or eliminate such area, it is also needed to reduce the thickness of the coupling apparatus.

Consideration is made of the structure of the proposed technique in line with the above needs. In the proposed technique, external load is born by fastening both the plates through the contact between the master side tapered surface in the arcuate outer periphery of the cam member and the ball members and the contact between the ball members and the tool side tapered surface in the arcuate inner periphery of the ball retainer. Therefore, in order to reduce the increase in surface pressure at each contact point, large-diameter ball members must be used. Thus, not only the thickness of the coupling apparatus becomes thicker by the diameter increase of the large-diameter ball members, but also the operating stroke of the cam member in the direction of thickness of the coupling apparatus must be increased in order to push the ball members radially outward. The increase of the operating stroke also increases the thickness of the coupling apparatus, which presents a difficulty in achieving a sufficient thinning of the coupling apparatus.

Alternatively, in order to reduce the surface pressure at each contact point, the ball members may be replaced with roller members. In this case, the contact area between the master side tapered surface in the cam member outer periphery and the roller members and the contact area between the roller members and the tapered surface in the inner periphery of the ball retainer (roller stopper) become larger than in the case of using the ball members, thereby reducing the surface pressure at each contact point.

In this case, there is no difference in effect from the former case but that, out of four-directional curvature radii determining the surface pressure at each contact point, one in the axial direction of the corresponding roller is linear, and the additional effect is small. Therefore, this approach inevitably involves to increase the diameter of each roller member and cannot be an effective solution to make the thickness of the coupling apparatus as thin as possible.

Furthermore, the roller members are required, unlike the ball members, to have a structure capable of rolling without tilting (lodging) when pushed out. If this is accomplished, not only the number of parts increases but also the difficulty in machining the structure for accommodating the roller members becomes high, which inevitably invites cost rise.

The present invention has been made in view of the above points and, therefore, its object is to make the robot arm coupling apparatus as described above thinner while employing ball members by improving the structure of the robot arm coupling apparatus.

### DISCLOSURE OF THE INVENTION

To attain the above object, in the present invention, each ball member is placed in corresponding ball receiving grooves of substantially arcuate cross section formed in both of a cam member and a ball retainer and the inner surfaces of the ball receiving grooves are each brought into contact with the ball member, thereby increasing their contact areas.

Specifically, the present invention is directed to a robot arm coupling apparatus comprising: a master plate attached to a robot arm; a tool plate to which a tool or like element is attachable; and a locking device for joining and locking both the plates together, said locking device including: a cam member supported to the master plate slidably between a locking position and an unlocking position; a plurality of ball members arranged around the cam member and supported to the master plate for movement substantially orthogonal to a sliding direction of the cam member; and a ball retainer disposed at the tool plate and engageable with the ball members to hold both the plates connected to each other when the cam member moves to the locking position.

Furthermore, the present invention is characterized in that the cam member has a plurality of master side ball receiving grooves of substantially arcuate cross section formed to extend substantially along the sliding direction of the cam member and each capable of receiving one corresponding said ball member, said master side ball receiving grooves being spaced in the circumferential direction of the cam member in correspondence with the positions of the ball members, and the ball retainer has a plurality of tool side ball receiving grooves of substantially arcuate cross section formed to extend substantially along the sliding direction of the cam member and each capable of receiving one corresponding said ball member, said tool side ball receiving grooves being spaced in the circumferential direction of the ball retainer in correspondence with the positions of the ball members.

Moreover, the present invention is characterized in that the inner surface of each said master side ball receiving groove is formed with a master side first inclined portion whose cross section taken lengthwise of the groove has a shape inclined in a specified direction with respect to the sliding direction of the cam member, the inner surface of each said tool side ball receiving groove is formed with a tool side inclined portion whose cross section taken lengthwise of the groove has a shape inclined opposite to the direction of inclination of the master side inclined portion, and the robot arm coupling apparatus is configured so that when the cam member is positioned in the locking position, each said master side first inclined portion pushes one corresponding said ball member against one corresponding said tool side inclined portion.

With this configuration, when the cam member moves to the locking position, it pushes, with the master side first inclined portions of its master side ball receiving grooves, the ball members against the tool side inclined portions of the toll side ball receiving grooves in the ball retainer. The wedge effect of the master side first inclined portions urges the ball members to pushed radially outward. Thus, the ball members push the ball retainer and the tool plate through the tool side inclined portions to urge them towards the master plate, thereby connecting both the plates with no gap therebetween.

During the connection, since each ball member is recessed in the corresponding master side ball receiving groove of substantially arcuate cross section in the cam member and the corresponding, similar tool side ball receiving groove in the ball retainer, the ball member makes contact with the respective inner surfaces (essentially, the bottom surfaces) of the master side ball receiving groove and the tool side ball receiving groove. The contact is a contact of the outer periphery of the ball member with the inner surfaces of the ball receiving grooves, i.e., a contact between the arcuate surfaces curved in the same direction. Therefore, as compared to the contact configuration of the ball member with the master side tapered surface in the outer periphery of the cam member and the tool side tapered surface in the inner periphery of the ball retainer, i.e., the contact configuration between their arcuate surfaces curved in opposite directions, the contact area can be increased. In other words, even with the use of small-diameter ball members, the contact area can be increased to reduce the contact surface pressure. This makes it possible for the ball members to have a smaller diameter, thereby making the operating stroke of the cam member smaller and, in turn, making the robot arm coupling apparatus thinner.

The robot arm coupling apparatus may be configured so that the inner surface of each said master side ball receiving groove has a straight portion located closer to the locking position of the cam member than the master side first inclined portion and joined to the master side first inclined portion, the cross section of said straight portion taken lengthwise of the groove being parallel to the sliding direction of the cam member.

With this configuration, since the straight portion is joined to the master side first inclined portion towards the locking position of the cam member, even if the slid position of the cam member is not held in the specified position so that the ball members are displaced radially inward to move back the cam member towards the unlocking position, i.e., on the retracting side, the force of the ball members to retract the cam member becomes ineffective at that straight portion, whereby separation between the master plate and the tool plate is prevented.

The robot arm coupling apparatus may be configured so that the inner surface of each said master side ball receiving groove is formed with a master side second inclined portion located closer to the locking position of the cam member than the straight portion, the cross section of said master side second inclined portion taken lengthwise of the groove being inclined in the same direction as the direction of inclination of the master side first inclined portion, and the straight portion and the master side second inclined portion continue through an arcuate portion whose cross section taken lengthwise of the groove is arcuate.

Alternatively, the robot arm coupling apparatus may be configured so that the inner surface of each said master side ball receiving groove has an arcuate portion located closer to the locking position of the cam member than the straight portion and joined to the straight portion, the cross section of said arcuate portion taken lengthwise of the groove being inclined substantially in the same direction as the direction of inclination of the master side first inclined portion.

The radius of each said master side ball receiving groove and/or each said tool side ball receiving groove preferably ranges from 0.05 mm larger to twice larger than the radius of each said ball member. Alternatively, the radius of each said master side ball receiving groove and/or each said tool side ball receiving groove may range from 0.05 mm larger to 1.5 times larger than the radius of each said ball member.

A rotation stop mechanism is preferably provided for inhibiting the cam member from rotating relative to the master plate about an axis along the sliding direction of the cam member. If the cam member is held against rotation in this manner, the master side ball receiving grooves in the cam member can be associated one with each of the ball members and can receive the corresponding ball members not only when the cam member is in the locking position but also when it is in the unlocking position, namely, at any time, thereby providing a stable operation.

The master plate may comprise a master body to be attached to the robot arm by a first fastening member and a cylinder head fixed to the master body by a second fastening member different from the first fastening member and having a ball accommodation part for accommodating the ball members.

Thus, only the master body can be attached to the robot arm by the first fastening member. As compared to the structure in which the master body and the cylinder head are together attached to the robot arm by the common fastening member, the robot arm coupling apparatus can be made thinner and can keep a large strength.

A master plate for a robot arm coupling apparatus attached to a robot arm and connectable to a tool plate including a ball retainer may have the following configuration. Specifically, the ball retainer is formed with a plurality of tool side ball receiving grooves of substantially arcuate cross section, and the inner surface of each said tool side ball receiving groove has a tool side inclined portion whose cross section taken lengthwise of the groove has a shape inclined in a specified direction.

Furthermore, the master plate comprises: a cam member slidable between a locking position and an unlocking position; and a plurality of ball members arranged around the cam member for movement substantially orthogonal to a sliding direction of the cam member, said ball members being configured, upon movement of the cam member to the locking position, to come into contact with the corresponding tool side inclined portions of the ball retainer and hold the tool plate connected to the master plate. Moreover, the cam member has a plurality of master side ball receiving grooves of substantially arcuate cross section formed to extend substantially along the sliding direction of the cam member and each capable of receiving one corresponding said ball member, said master side ball receiving grooves being spaced in the circumferential direction of the cam member in correspondence with the positions of the ball members, and the inner surface of each said master side ball receiving groove is formed with a master side inclined portion whose cross section taken lengthwise of the groove has a shape inclined opposite to the direction of inclination of the tool side inclined portion, said master side inclined portion pushing one corresponding said ball member against one corresponding said tool side inclined portion when the cam member is positioned in the locking position.

A tool plate for a robot arm coupling apparatus may be configured as described below, said tool plate being connectable to a master plate including: a cam member slidable between a locking position and an unlocking position and having a plurality of master side ball receiving grooves of substantially arcuate cross section each having an inner surface formed with a master side inclined portion whose cross section taken lengthwise of the groove has a shape inclined in a specified direction; and a plurality of ball members arranged in the master plate around the cam member for movement substantially orthogonal to a sliding direction of the cam member, said plurality of ball members being configured, upon movement of the cam member to the locking position, to be pushed and moved by the corresponding master side inclined portions. Specifically, a ball retainer is provided which has a plurality of tool side ball receiving grooves of substantially arcuate cross section each having an inner surface formed with a tool side inclined portion whose cross section taken lengthwise of the groove has a shape inclined opposite to the direction of inclination of the master side inclined portion, said toll side inclined portion being capable of contact with one corresponding said ball member of the master plate, and the tool plate is configured, upon movement of the cam member to the locking position, to be held connected to the master plate by bringing the ball members moving under the pushing of the master side inclined portions into contact with the corresponding tool side inclined portions of the ball retainer.

### BRIEF DESCRIPTION OF DRAWINGS

FIG. 1 is a longitudinal cross-sectional view showing a robot arm coupling apparatus according to an embodiment of the present invention when both the plates are connected.

FIG. 2 is a longitudinal cross-sectional view of the master plate.

FIG. 3 is a longitudinal cross-sectional view of the tool plate.

FIG. 4 is a cross-sectional view taken along the line IV-IV in FIG. 5.

FIG. 5 is an enlarged front view of a master side ball receiving groove when viewed from one side of a cam member.

FIG. 6 is an enlarged plan view of the master side ball receiving groove when viewed from below the cam member.

FIG. 7 is a cross-sectional view taken along the line VII-VII in FIG. 9.

FIG. 8 is a perspective view of the cam member.

FIG. 9 is a plan view of the cam member when viewed from below.

FIG. 10 is a plan view of a ball retainer when viewed from below.

FIG. 11 is a perspective view of the ball retainer.

FIG. 12 is a cross-sectional view taken along the line XII-XII in FIG. 10.

FIG. 13 is an enlarged front view of a tool side ball receiving groove when viewed from the inside of the ball retainer.

FIG. 14 is an enlarged plan view of the tool side ball receiving groove when viewed from below the ball retainer.

FIG. 15 is a cross-sectional view taken along the line XV-XV in FIG. 13.

FIG. 16 is a plan view of a master cylinder when viewed from below.

FIG. 17 is an enlarged cross-sectional view of a ball accommodation hole.

FIG. 18 is a view corresponding to FIG. 4, showing another embodiment.

### BEST MODE FOR CARRYING OUT THE INVENTION

An embodiment of the present invention will be described below in detail with reference to the drawings. The following description of the preferred embodiment is merely illustrative in nature and is not at all intended to limit the scope, applications and use of the invention.

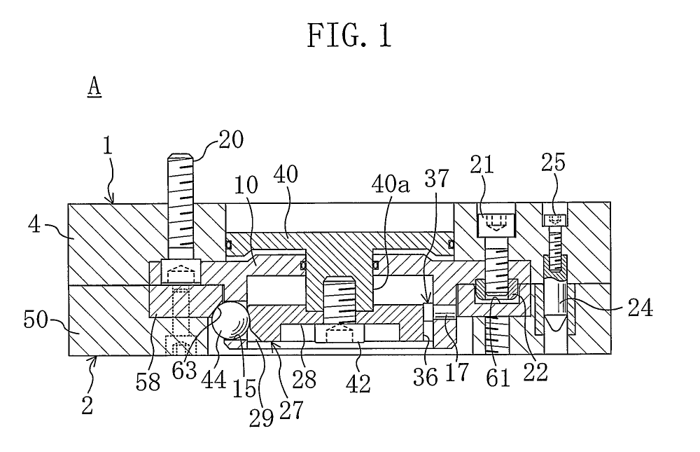

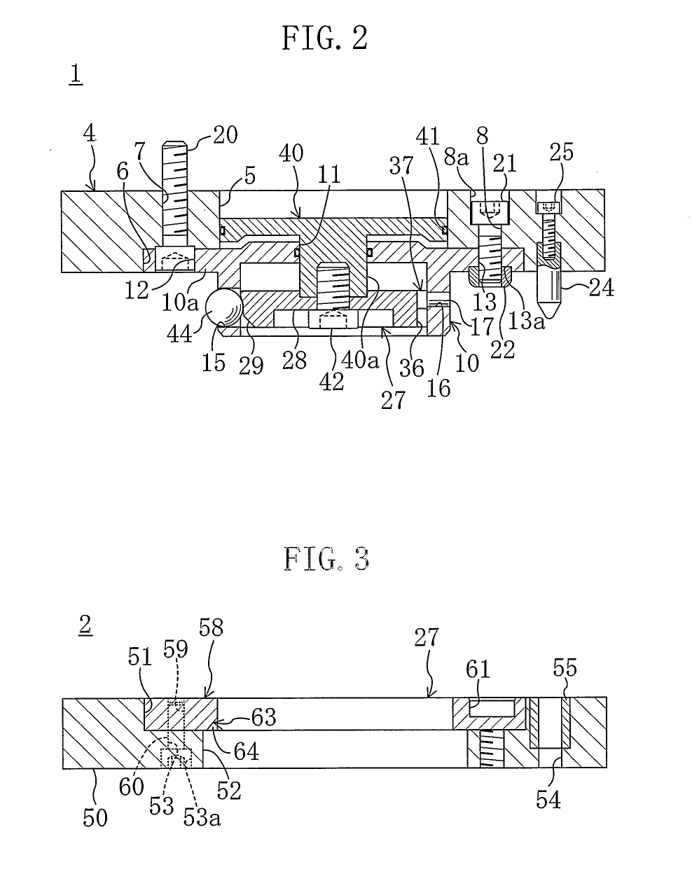

FIG. 1 shows an essential part of a robot arm coupling apparatus A according to an embodiment of the present invention. This robot arm coupling apparatus A is for exchangeably mounting a tool or like element to an unshown robot arm and includes a mater plate 1 shown in FIG. 2 and a tool plate 2 shown in FIG. 3. The master plate 1 is attached to the robot arm and a tool or like element is attached to the tool plate 2. Both the plates 1, 2 are configured to be quickly connected to and disconnected from each other by a locking mechanism 27.

Though not shown, the master plate 1 and the tool plate 2 have a master connecter and a tool connector, respectively, attached thereto. In connecting both the plates 1, 2, the master connecter and the tool connector are electrically connected to each other and the connection establishes an electric control system for controlling the tool. For convenience of explanation, the following description is given regarding the mater plate 1 and the tool plate 2 as placed above (on the robot arm side) and below, respectively.

The master plate 1 includes a master body 4 to be attached to the robot arm by first bolts 20 (first fastening members) and a cylinder head 10 integrally fixed to the bottom of the master body 4 by second bolts 21 (second fastening members) different from the first bolts 20 and having a plurality of ball accommodation holes 15, 15, . . . each for accommodating one of a plurality of ball members 44, 44, . . .

The master body 4 has a ring shape in which a small-diameter hole 5 located in an upper side thereof and a large-diameter hole 6 continuing concentrically to the small-diameter hole 5 to form a shoulder are formed through the center of the master body 4. The shoulder between the small-diameter hole 5 and the large-diameter hole 6 has a plurality of (e.g., eight) first bolt insertion holes 7, 7, . . . and a plurality of (e.g., eight) second bolt insertion holes 8, 8, . . . formed therethrough and alternated in the circumferential direction. An opening of each second bolt insertion hole 8 located at the top surface of the master body 4 is formed into a bolt head receiving part 8a larger in diameter than the other part.

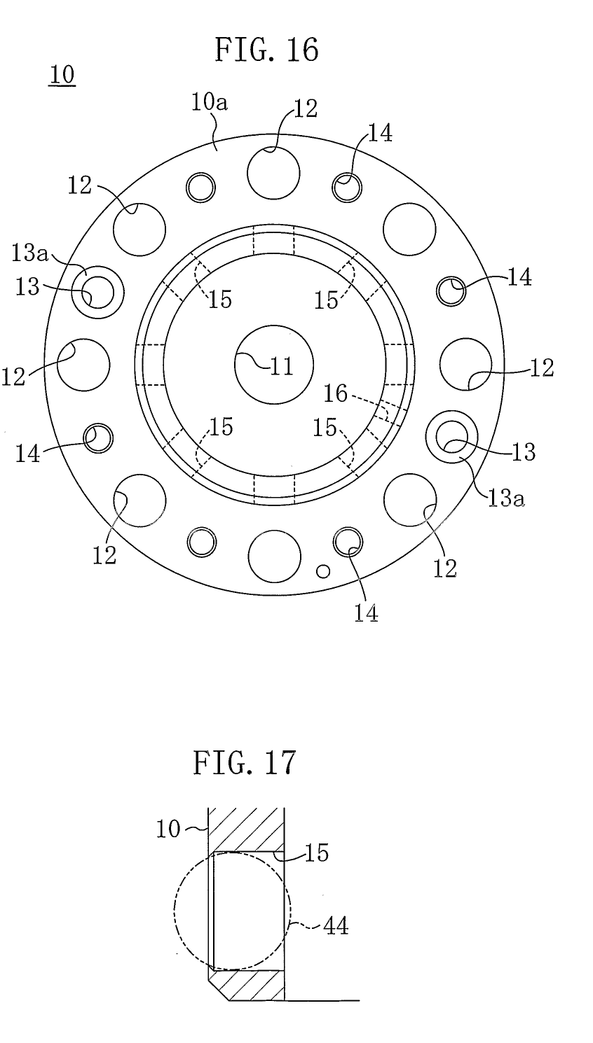

On the other hand, the cylinder head 10 is in the shape of a downwardly opening, bottomed cylinder, as also shown in FIG. 16, and has a rod part insertion hole 11 formed therethrough at the center of the bottom. The upper end of the outer periphery of the cylinder head 10 is formed integrally with a flange 10a which is fitted into the large-diameter hole 6 of the master body 4 so that the bottom surface of the flange 10a is flush with the bottom surface of the master body 4. The flange 10a has bolt head receiving holes 12 formed through it at its positions corresponding to the first bolt insertion holes 7 in the master body 4 and having a larger diameter than the first bolt insertion holes 7, has a pair of bolt insertion holes 13, 13 formed through it at its positions corresponding to a specified, diametrically opposed pair 8, 8 of the second bolt insertion holes 8, 8, . . . in the master body 4, and has bolt screwing holes 14 formed through it at its positions corresponding to the remaining second bolt insertion holes 8. An opening of each bolt insertion hole 13 at the bottom surface of the cylinder head 10 is formed into a pin receiving part 13a having a larger diameter than the other part thereof.

The flange 10a of the cylinder head 10 is fitted into the large-diameter hole 6 of the master body 4 and, in this state, the first bolts 20 are inserted from below the cylinder head 10 into the bolt head receiving holes 12 in the flange 10a and the first bolt insertion holes 7 in the master body 4, thereby projecting the distal ends (upper ends) of the first bolts 20 upward beyond the master body 4. The projecting portions of the first bolts 20 are screwed and tightened into the robot arm, whereby the master body 4 is fixed integrally to the robot arm in gas-tight manner. On the other hand, the second bolts 21 are inserted from above the master body 4 into the second bolt insertion holes 8 in the master body 4. Out of the second bolts 21, a pair of second bolts 21, 21 are inserted into the bolt insertion holes 13 in the flange 10a so that their distal ends (lower ends) pass through them to project below beyond the flange 10a. The projecting portions of the second bolts 21, 21 are screwed and tightened into positioning pins 22. The rest of the second bolts 21 are screwed and tightened at their distal ends (lower ends) into the bolt screwing holes 14 in the flange 10a. In this manner, the cylinder head 10 is fixed integrally to the master body 4 in gas-tight manner by the second bolts 21. The heads of the second bolts 21 are received in bolt head receiving parts 8a of the second bolt insertion holes 8 in the master body 4 against projecting beyond the top surface of the master body 4, while the heads of the first bolts 20 are received in bolt head receiving holes 12 in the cylinder head 10 against projecting beyond the bottom surface of the flange 10a. Furthermore, when the master body 4 is attached to the robot arm, the upper opening of the small-diameter hole 5 is closed in gas-tight manner so that a closed cylinder space is created by the small-diameter hole 5, the top surface of the cylinder head 10 and the robot arm.

The positioning pins 22 screwed onto the lower ends of the pair of second bolts 21, 21 (second fastening members) act also as fastening nuts and are screwed onto the second bolts 21, 21 with their upper portions received in pin receiving parts 13a of the bolt insertion holes 13 and their lower portions projecting beyond the bottom surface of the flange 10a. Each positioning pin 22 is formed in the shape of a short cylinder of relatively large diameter in which the corners of the lower end are rounded to form arcuate surfaces.

At part of the bottom surface of the master body 4 outwardly of the large-diameter hole 5, a pair of guide pins 24, 24 for robot teaching with their distal ends (lower ends) tapered are attached oppositely in the diametrical direction of the master cylinder so that their lower portions are projected beyond the bottom surface of the master body 4. Each guide pin 24 is fixed to the master body 4 by a mounting bolt 25 passing therethrough.

The lower part of the cylinder head 10 has the plurality of (e.g., eight) ball accommodation holes 15, 15, . . . formed at circumferentially spaced intervals to radially pass through the cylinder head 10 from inside to outside and has a single pin hole 16 formed between specified two ball accommodation holes 15, 15 to radially pass through the cylinder head 10 from inside to outside. A rotation stop pin 17 is inserted and fixed in the pin hole 16 with its part (engagement part) projecting to the interior of the cylinder head 10. As shown in FIG. 17 in enlarged manner, the open end of each ball accommodation hole 15 at the outer periphery of the cylinder head 10 has a smaller diameter than the other part, whereby the ball member 44 in the ball accommodation hole 15 is held against dropping out of the hole beyond the outer periphery of the cylinder head 10.

The locking mechanism 27 includes a cam member 28 supported to the master plate 1 slidably between its locking position and unlocking position, the plurality of ball members 44, 44, . . . arranged around the cam member 28 and supported to the master plate 1 movably along a direction (radial direction) substantially orthogonal to the sliding direction of the cam member 28 (the vertical direction), and a ball retainer 58 disposed at the tool plate 2 and engageable with the ball members 44 to hold both the plates 1 and 2 connected to each other when the cam member 28 moves to the locking position.

Each ball member 44 is constituted, for example, by a steel ball having a diameter of 12.7 mm (radius r=6.35 mm) and accommodated and retained in the corresponding ball accommodation hole 15 in the cylinder head 10 movably along the radial direction of the master plate 1.

Furthermore, a piston 40 is slidably inserted and fitted in the small-diameter hole 5 (the cylinder space) of the master body 4. The piston 40 is in the shape of a disc slidable in the small-diameter hole 5 through a sealing member 41 constituted by an O-ring. The piston 40 has a rod part 40a integrally extending from the center of the bottom surface and slidably passing through the rod part insertion hole 11 in the cylinder head 10 in gas-tight manner. The piston 40 divides the interior (cylinder space) of the small-diameter hole 5 in the master body 4 into two rooms from top to bottom and is configured to reciprocate within the small-diameter hole 5 by selectively supplying pressurized air to one of the rooms through an air passage (not shown) formed in the master body 4.

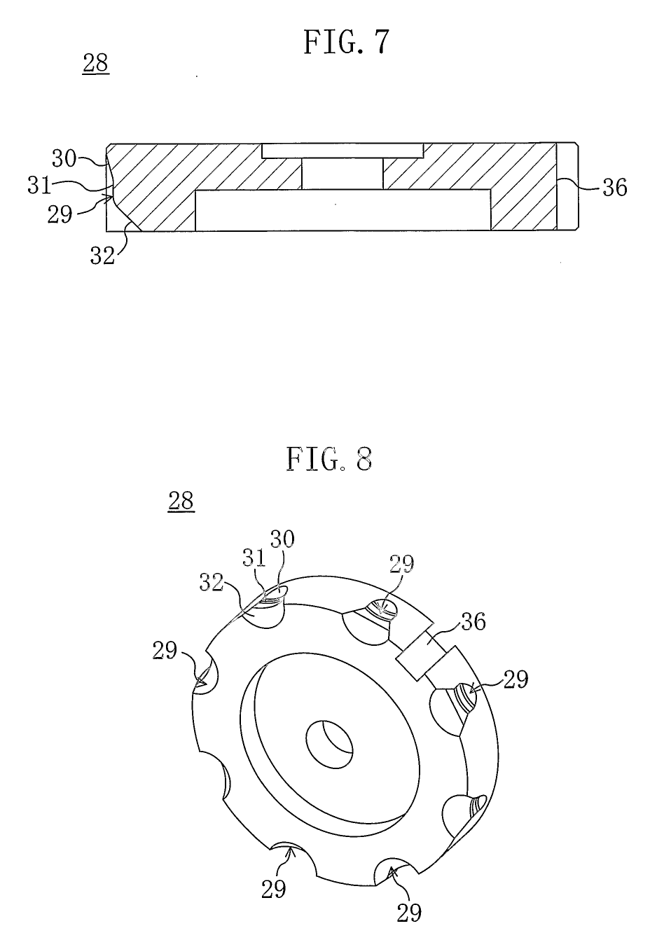

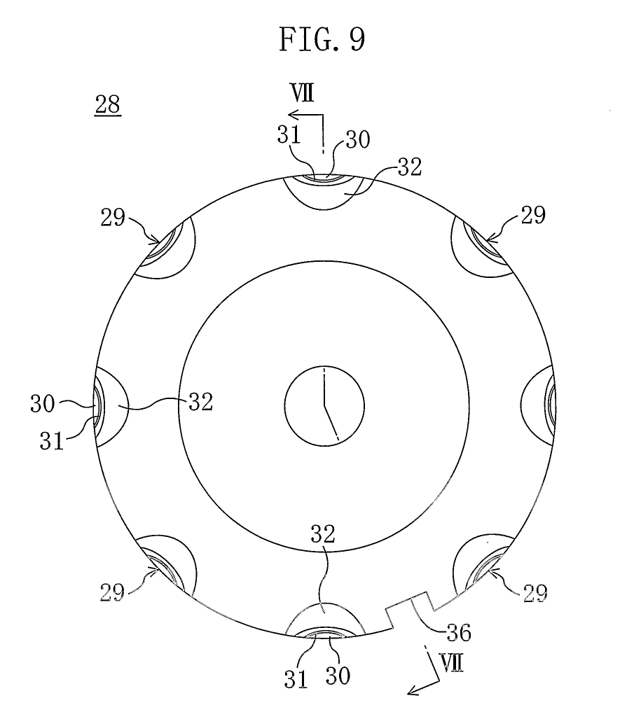

The cam member 28 is placed in the cylinder head 10 slidably between its locking position located at the descending end and its unlocking position located at the ascending end. As shown in FIGS. 7 to 9, the cam member 28 is in the shape of a disc and fastened at the center to the distal end (lower end) of the rod part 40a of the piston 40 for unitary movement by a connecting bolt 42. When the piston 40 reciprocates, the cam member 28 is actuated to slide in the cylinder head 10 between the locking position and the unlocking position.

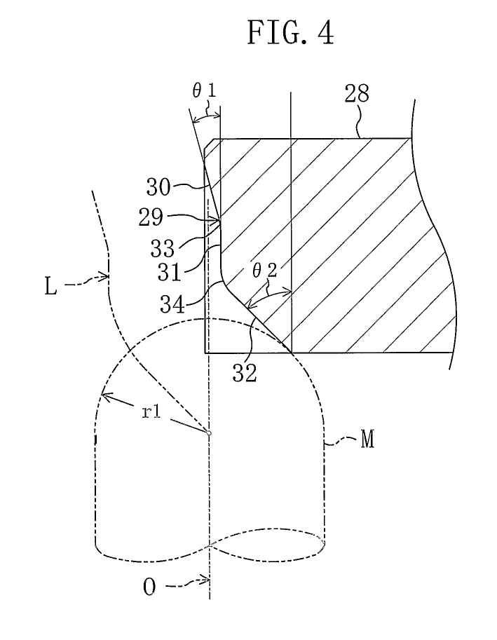

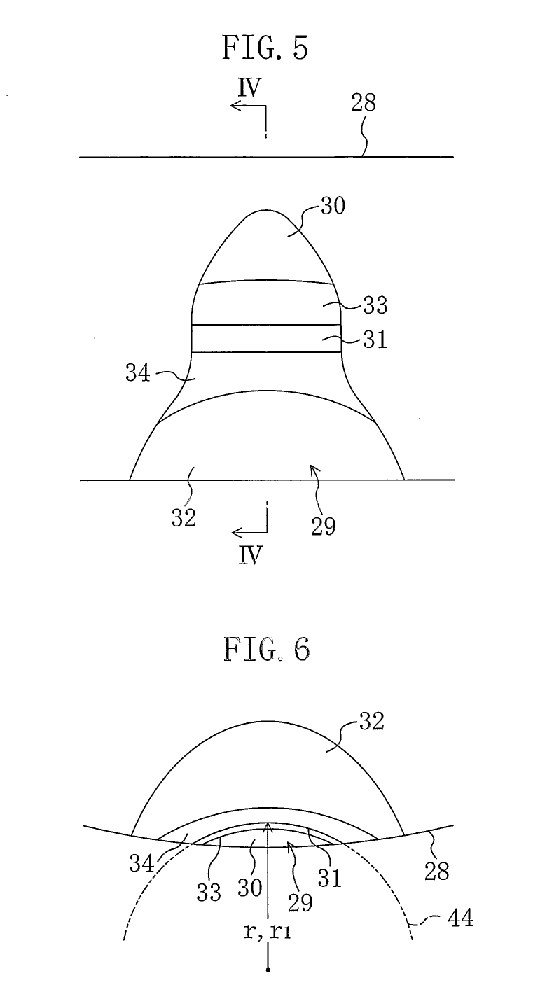

The outer periphery of the cam member 28 has a plurality of (e.g., eight) master side ball receiving grooves 29, 29, . . . of arcuate cross section formed arranged in the circumferential direction of the cam member 28 in correspondence with the positions of the ball members 44 (the positions of the ball accommodation holes 15 in the cylinder head 10). As shown in FIGS. 4 to 6 in enlarged and detailed manner, each master side ball receiving groove 29 is shaped so that the corner of the cam member 28 at the lower end of the outer periphery is partly cut out in the shape of an arcuate groove. The master side ball receiving groove 29 generally extends along the sliding direction of the cam member 28 (the vertical direction) and has an upper end located not at the top surface of the cam member 28 but in the vicinity of the upper end of the outer periphery to be able to receive the corresponding ball member 44 in the master side ball receiving groove 29. The master side ball receiving groove 29 may be formed so that its upper end reaches the top surface of the cam member 28.

The inner surface (essentially, the bottom surface) of each master side ball receiving groove 29 is formed with a master side first inclined portion 30, a straight portion 31 continuing to the master side first inclined portion 30 and located closer to the locking position of the cam member 28 (lower) than it, and a master side second inclined portion 32 continuing to the straight portion 31 and located closer to the locking position of the cam member 28 (lower) than it. The master side first inclined portion 30 and the straight portion 31 continue through an upper arcuate portion 33, while the straight portion 31 and the master side second inclined portion 32 continue through a lower arcuate portion 34. The first inclined portion 30, the straight portion 31, the second inclined portion 32 and the arcuate portions 33, 34 are all located in the inner surface (bottom surface) of the master side ball receiving groove 29. Though each master side ball receiving groove 29 has the same groove radius r1 at every point in the groove, it can be formed by changing its arc center. The formation of a master side ball receiving groove 29 of an arc radius of r1 having such a shouldered groove bottom surface is easily implemented by using an end mill M having a head with a radius of r1 to cut the cam member 28 while moving the center O of the end mill M along a specified locus L.

The master side first inclined portion 30 and the master side second inclined portion 32 each have a shape inclined oppositely to the direction of inclination of the later-described tool side inclined portion 64 so that their cross sections taken lengthwise of the groove go towards the center of the cam member 28 (to the right in FIG. 4) with approach downward in the sliding direction of the cam member 28. The angle θ1 of inclination of the first inclined portion 30 with respect to the vertical direction (the vertical axis) may be equal to the angle θ2 of inclination of the second inclined portion 32 (i.e., θ1=θ2). In this embodiment, however, in order to enhance the wedge effect of the second inclined portion 32 and surely hold the connecting position even upon abrupt movement of the robot arm, the angle θ1 of inclination of the first inclined portion 30 is set smaller than the angle θ2 of inclination of the second inclined portion 32 (θ1<θ2). For example, the angle θ1 of inclination of the first inclined portion 30 is θ1=15°, while the angle θ2 of inclination of the second inclined portion 32 is θ2=45°.

The straight portion 31 is shaped so that its cross section taken lengthwise of the groove is parallel with the sliding direction of the cam member 28, and its angle of inclination with respect to the vertical direction (the vertical axis) is zero. Further, the upper arcuate portion 33 and the lower arcuate portion 34 are shaped so that their cross sections taken lengthwise of the groove each have a shape of a rounded arc. The upper arcuate portion 33 and the lower arcuate portion 34 bulge towards the center and the outer periphery, respectively, of the cam member 28 and, that is, the bulging directions of the arcuate portions 33 and 34 are opposite to each other. The upper arcuate portion 33 joins the master side first inclined portion 30 and the straight portion 31 to smoothly continue, while the lower arcuate portion 34 joins the straight portion 31 and the master side second inclined portion 32 to smoothly continue.

The outer periphery of the cam member 28 has an engagement groove 36, for example, of rectangular cross section formed at a position corresponding to the pin hole 16 in the cylinder head 10 to extend along the sliding direction of the am member 28 and span the top and bottom surfaces of the cam member 28. The engagement groove 36 is engaged with the engagement part of the rotation stop pin 17 inserted in the pin hole 16 to allow sliding motion of the engagement part. The rotation stop pin 17 and the engagement groove 36 constitute a rotation stop mechanism 37 for inhibiting the cam member 28 from rotating relative to the master plate 1 about the vertical axis along the sliding direction of the cam member 28.

The tool plate 2 includes a tool body 50 attachable to a tool or like element and a ball retainer 58 fixed to the upper side of the tool body 50 and constituting part of the locking mechanism 27. The tool body 50 has a ring shape in which an upper large-diameter hole 51 and a lower small-diameter hole 52 continuing concentrically to the large-diameter hole 51 to form a shoulder are formed through the center of the tool body 50. The shoulder between the large-diameter hole 51 and the small-diameter hole 52 has a plurality of (e.g., 16) bolt insertion holes 53, 53, . . . formed therethrough at circumferentially spaced intervals. An opening of each second bolt insertion hole 53 located at the bottom surface of the tool body 50 is formed into a bolt head receiving part 53a larger in diameter than the other part.

Furthermore, in part of the top surface of the tool body 50 outwardly of the large-diameter hole 51, a pair of shouldered pin insertion holes 54, 54 are formed through the tool body 50 oppositely in the diametrical direction of the tool body 50 and in correspondence with the positions of the guide pins 24 of the master body 4. A bush 55 having a larger inner diameter than the guide pin 24 is fixedly fitted in the upper part of each pin insertion hole 54. In teaching the robot, each guide pin 24 is inserted and fitted into the bush 55 of the corresponding pin insertion hole 54.

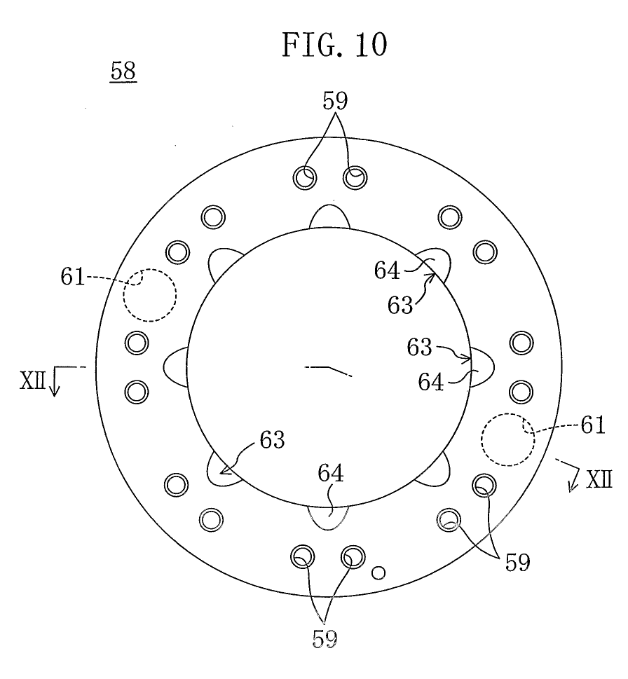

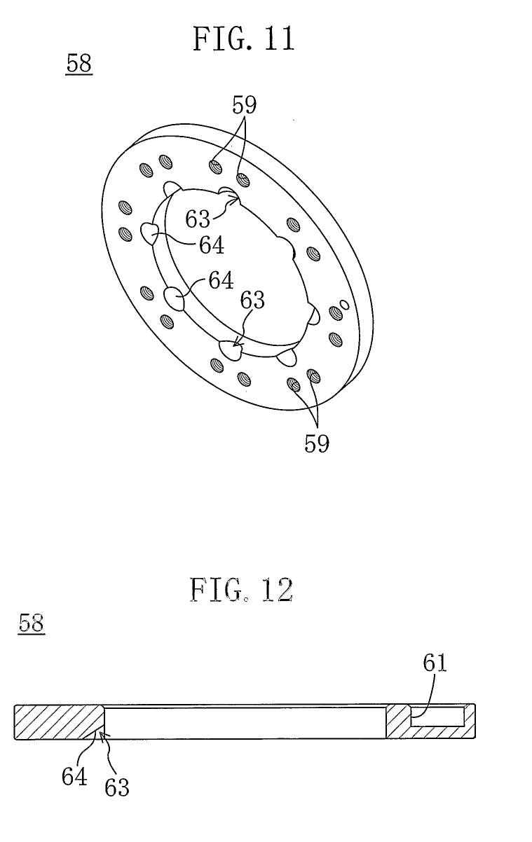

As also shown in FIGS. 10 to 12, the ball retainer 58 has a ring shape having a smaller inner diameter than the small-diameter hole 52 in the tool body 50 and is fitted into the large-diameter hole 51 of the tool body 50 so that its top surface is flush with the bottom surface of the tool body 50. The ball retainer 58 has bolt screwing holes 59 formed through it at its positions corresponding to the bolt insertion holes 53 in the tool body 50. The ball retainer 58 is fitted into the large-diameter hole 51 in the tool body 50, fastening bolts 60 are inserted from below the tool body 50 into the bolt insertion holes 53 in the tool body 50 and their distal ends (upper ends) are screwed and tightened into the corresponding bolt screwing holes 59 in the ball retainer 58, whereby the ball retainer 58 is fixed integrally to the tool body 50.

Furthermore, the top surface of the ball retainer 58 has a pair of positioning fitting holes 61 formed oppositely in the diametrical direction and each constituted by a shallow, bottomed hole fittable on the positioning pins 22 on the master plate 1. In connecting the tool plate 2 to the master plate 1, the positioning pins 22 are fitted into the positioning fitting holes 61, whereby the ball members 44 in the corresponding ball accommodation holes 15 of the cylinder head 10 (and the master side ball receiving grooves 29 in the cam member 28) are positioned circumferentially corresponding to the later-described tool side ball receiving grooves 63 in the ball retainer 58.

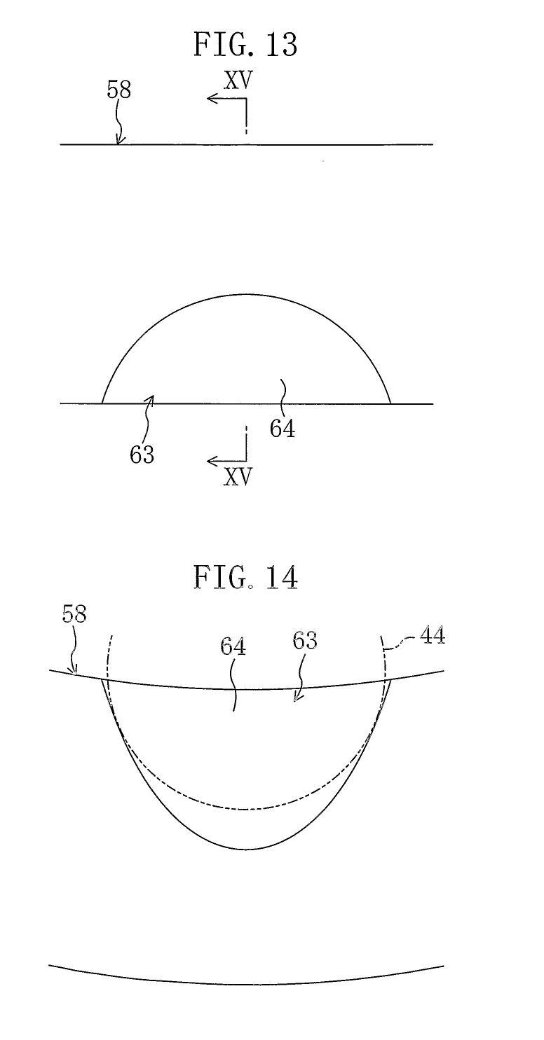

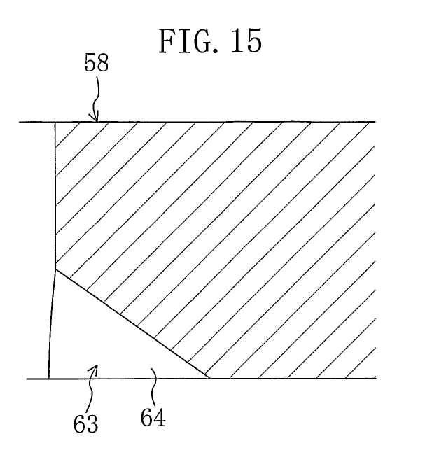

The lower part of the inner periphery of the ball retainer 58 has a plurality of (e.g., eight) tool side ball receiving grooves 63, 63, . . . of arcuate cross section formed arranged in the circumferential direction of the ball retainer 58 in correspondence with the positions of the ball members 44 of the master plate 1 (the positions of the master side ball receiving grooves 29 in the cam member 28). As shown in FIGS. 13 to 15 in enlarged and detailed manner, each tool side ball receiving groove 63 is shaped so that the corner of the ball retainer 58 at the lower end of the inner periphery is partly cut out in the shape of an arcuate groove. The tool side ball receiving groove 63 generally extends along the sliding direction of the cam member 28 (the vertical direction) and has an upper end located not at the top surface of the ball retainer 58 but in the vicinity of the top end of the inner periphery to be able to receive the corresponding ball member 44 in the tool side ball receiving groove 63. The arc radius r1 of the tool side ball receiving groove 63 is equal to the arc radius r1 of the master side ball receiving groove 29 (but both the ball receiving grooves 63, 29 may have different arc radii). The tool side ball receiving groove 63 may be formed so that its upper end reaches the top surface of the ball retainer 58.

The inner surface (essentially, the bottom surface) of each tool side ball receiving groove 63 is formed with a tool side first inclined portion 64. The tool side first inclined portion 64 is shaped so that its cross section taken lengthwise of the groove inclines oppositely to the direction of inclination of the master side first inclined portion 30 of the master side ball receiving groove 29, i.e., inclines to go towards the center of the ball retainer 58 with approach upward in the sliding direction of the cam member 28. Like the master side ball receiving groove 29, the tool side ball receiving groove 63 also has the same groove radius r1 at every point in the groove and can be formed by changing its arc center. The formation of a tool side ball receiving groove 63 of an arc radius of r1 having such a groove bottom surface is easily implemented by using the end mill M to cut the ball retainer 58 in the same manner as in the formation of the master side ball receiving groove 29.

The radius r1 of the master side ball receiving groove 29 and the tool side ball receiving groove 63 preferably ranges from 0.05 mm larger than the radius r (0.1 mm larger than the diameter) of the ball member 44 to twice larger than the radius (i.e., 0.05 mm+r≦r1≦2r). The reason for this is as follows: if r1<0.05 mm+r, this does not ensure that the ball member 44 smoothly rolls on the ball receiving groove 29, 63; if r1>2r, this does not provide a good surface-pressure reducing effect between the inner surface of each ball receiving groove 29, 63 and the outside surface of the ball member 44. More preferably, the upper limit of the radius r1 of the ball receiving groove 29, 63 is not 1.5 times larger than the radius r of the ball member 44 (0.05 mm+r≦r1≦1.5r).

When the cylinder head 10 of the master plate 1 is inserted and fitted into the inside of the ball retainer 58 and the small-diameter hole 52 of the tool body 50 of the tool plate 2 and the positioning pins 22 are fitted and engaged into the positioning fitting holes 61, the ball members 44 of the master plate 1 are associated with the tool side ball receiving grooves 63 in the ball retainer 58. When in this state the piston 40 is actuated to position the cam member 28 into the locking position, the master side first inclined portions 30 at the upper ends of the master side ball receiving grooves 29 press the ball members 44 against the tool side inclined portions 64 of the tool side ball receiving grooves 63, thereby joining and locking the tool plate 2 and the master plate 1 together.

Next, a description is given of the operation of this embodiment. First, in connecting the tool plate 2 to the master plate 1, the robot arm is operated to insert the cylinder head 10 of the master plate 1 into the interior of the ball retainer 58 and the small-diameter hole 52 of the tool body 50 of the tool plate 2. Further, the pair of positioning pins 22, 22 on the master plate 1 are fitted into the pair of positioning fitting holes 61, 61 in the tool plate 2. In this state, the ball members 44 supported in the corresponding ball accommodation holes 15 in the cylinder head 10 are circumferentially associated with the corresponding tool side ball receiving grooves 63 in the ball retainer 58. The ball members 44 are also circumferentially associated with the corresponding master side ball receiving grooves 29 in the cam member 28 by the rotation stop mechanism 37.

When in this state pressurized air is supplied to the room above the piston 40, the piston 40 moves down from its rising position and this actuation of the piston 40 causes the cam member 28 to move down from the unlocking position located at its ascending end. The downward movement of the cam member 28 causes the ball members 44 to enter the master side ball receiving grooves 29, whereby the master side second inclined portion 32 at the lower end of the inner surface of each ball receiving groove 29 pushes the corresponding ball member 44 radially outward to project it from the outer periphery of the cylinder head 10. Thus, the projecting portion of each ball member 44 enters the corresponding tool side ball receiving groove 63. When the cam member 28 further moves down, the straight portion 31 above the master side second inclined portion 32 pushes the ball member 44. Then, when the cam member 28 is positioned in the locking position at its descending end, the master side first inclined portion 30 located above the straight portion 31 and at the upper end of the master side ball receiving groove 29 pushes the ball member 44, whereby the ball member 44 abuts against the tool side inclined portion 64 of the corresponding tool side ball receiving groove 63. In this state, each ball member 44 abuts against the master side first inclined portion 30 of the corresponding master side ball receiving groove 29 and the tool side inclined portion 64 of the corresponding tool side ball receiving groove 63 and the lower part of the inner surface of the corresponding ball accommodation hole 15 and is held pushed against movement by them. Thus, the tool plate 2 and the master plate 1 are joined and locked together.

Specifically, in this case, the air pressure acts on the top surface of the piston 40 and the cam member 28 integral with the piston 40 is also pushed down, so that the master side first inclined portion 30 at the upper end of the inner surface of each master side ball receiving groove 29 pushes the outer periphery of the corresponding ball member 44. Therefore, by a so-called wedge effect of the master side first inclined portion 30, the corresponding ball member 44 is moved radially outward until it reaches a specified position. In addition, since the angle θ1 of inclination of the master side first inclined portion 30 is small, the wedge effect is enhanced. Therefore, the tool plate 2 is urged upward by a pressing force acting from the ball members 44 on the tool side inclined portions 64 of the tool side ball receiving grooves 63 in the ball retainer 58, so that the top surface of the tool plate 2 moves until it reaches the bottom surface of the master plate 1. Even if, as a result, a gap is created between both the plates 1 and 2 owing to processing irregularities, such irregularities are absorbed by positively urging the ball members 44 radially outward by the master side first inclined portions 30 of the master side ball receiving grooves 29 to displace the tool plate 2 upward. Therefore, both the plates 1 and 2 are joined together with no gap created therebetween, which improves the reproducibility of their connecting position.

The top surface of the piston 40 always undergoes air pressure. If, however, the top surface of the piston 40 no longer undergoes air pressure for any reason, the ball members 44 are pushed and displaced radially inward by the weights of the tool plate 2 and the tool, whereby the piston 40 is lifted up. Even in this case, since the straight portion 31 are joined to the lower end of the master side first inclined portion 30, a force in a direction to raise the piston 40 does not act on the piston 40 from the ball members 44 after each ball member 44 moves to the straight portion 31. This restrains improper separation between both the plates 1 and 2.

In disconnecting the tool plate 2 from the master plate 1, pressurized air is supplied to the room below the piston 40 to raise the piston 40, so that an inverse operation with respect to the connecting of them is performed. Thus, the ball members 44 move radially inward to disconnect both the plates 1 and 2 from each other.

In this embodiment, each ball member 44 moves while being received in the corresponding master side ball receiving groove 29 of arcuate cross section in the cam member 28 and the corresponding, similar tool side ball receiving groove 63 in the ball retainer 58. Therefore, as shown in FIGS. 6 and 14, each ball member 44 comes into contact with the inner surfaces (essentially, the bottom surfaces) of the corresponding master side ball receiving groove 29 and tool side ball receiving groove 63. The contact is a contact of the outer periphery of the ball member 44 with the inner surfaces of the ball receiving grooves 29 and 63, i.e., a contact between the arcuate surfaces curved in the same direction. In this case of contact between the arcuate surfaces, the contact area increases as compared to the contact configuration of the ball member 44 with the master side tapered surface in the outer periphery of the conventional cam member and the too side tapered surface in the inner periphery of the conventional ball retainer, i.e., the contact configuration between their arcuate surfaces curved in opposite directions. Therefore, even with the use of the small-diameter ball members 44, the contact area can be increased to reduce the contact surface pressure. This makes it possible for the ball members 44 to have a smaller diameter, thereby making the operating stroke of the cam member 28 smaller and, in turn, making the thickness (height) of the robot arm coupling apparatus A thinner.

Furthermore, since the first bolts 20 used to attach the master body 4 to the robot arm are different from the second bolts 21 used to attach the cylinder head 10 to the master body 4, only the master body 4 can be attached to the robot arm with the first bolts 20. As compared to the structure in which the master body 4 and the cylinder head 10 are together attached to the robot arm with common bolts, the robot arm coupling apparatus A can be made thinner and can keep a large strength.

Furthermore, the rotation of the cam member 28 is inhibited by the rotation stop mechanism 37. Therefore, not only when the cam member 28 is in the locking position but also when it is in the unlocking position, the master side ball receiving groove 29 in the cam member 28 can be associated one with each of the ball members 44 (or each of the ball accommodation holes 15 in the cylinder head 10) and the ball members 44 can be received in the master side ball receiving grooves 29. This provides the retention of stable operation.

Furthermore, a short, large-diameter, cylindrical pin is used as each positioning pin 22 of the master plate 1. Therefore, even if torsional moment acts on the positioning pin 22, it is not largely displaced, which provides a stable positioning. Since the positioning fitting hole 61 in the tool plate 2 is a shallow, bottomed hole, this ensures that the positioning mechanism has a large strength.

If the positioning pin 22 is short as in the above case, it might be difficult to teach the robot. However, since the master body 4 is provided with the guide pins 24 for teaching in addition to the positioning pins 22, the robot teaching can be easily carried out using the guide pins 24.

### Other Embodiments

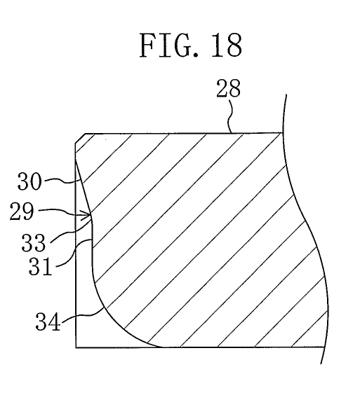

In the above embodiment, in each master side ball receiving groove 29, the straight portion 31 and the master side second inclined portion 32 smoothly continue through the rounded arcuate portion 34. As shown in FIG. 18, however, the master side second inclined portion 32 may be eliminated and the rounded arcuate portion 34 may be smoothly joined to the straight portion 31 at a position closer to the locking position of the cam member 28 than the straight portion 31 to incline substantially in the same direction as the direction of inclination of the master side first inclined portion 30. This also provides the same effects as in the above embodiment.

Furthermore, in the above embodiment, the first inclined portion 30, the straight portion 31, the second inclined portion 32 and the arcuate portions 33 and 34 are formed in each master side ball receiving groove 29. However, only the first inclined portion 30 may be formed therein and the other portions may be eliminated.

### EXAMPLES

The following Table 1 shows measurement results of decreasing changes in surface pressure between the outer periphery of a ball member 44 and the surface of each of corresponding ball receiving grooves 29, 63 where the radii r1 of both the ball receiving grooves 29, 63 are changed in a particular relation with the radius r of the ball member 44, and indicates the rates of surface pressure reduction of Inventive Examples when Comparative Example 1 has a rate of surface pressure reduction of 100%. The groove radii are r1=r+0.05 mm for Inventive Example 1, r1=1.25r for Inventive Example 2, r1=1.50r for Inventive Example 3, r1=1.75r for Inventive Example 4, and r1=2.00r for Inventive Example 5. Further, Comparative Example 1 has a contact configuration in which the ball members come into contact with the master side tapered surface in the outer periphery of the cam member and the tool side tapered surface in the inner periphery of the ball retainer, i.e., a contact configuration in which the arcuate surfaces curved in opposite direction come into contact. Comparative Example 2 has a contact configuration in which the ball members come into contact not with arcuate surfaces but with flat surfaces (where they are inclined cam surfaces).

TABLE 1

| | | Comparative | | | | | | |
|---|---|---|---|---|---|---|---|---|
| | Rate of surface | Example | | Inventive Example | | | | |
| Ball radius | pressure reduction | 1 | 2 | 1 | 2 | 3 | 4 | 5 |
| r (mm) | (%) | — | — | r + 0.05 mm | 1.25r | 1.50r | 1.75r | 2.00r |
| 5.5 | master side | 100 | 92 | 38 | 56 | 64 | 70 | 73 |
| | tool side | 100 | 105 | 43 | 64 | 74 | 80 | 84 |
| 6.35 | master side | 100 | 92 | 38 | 56 | 64 | 70 | 74 |
| | tool side | 100 | 105 | 43 | 64 | 73 | 80 | 84 |
| 7.5 | master side | 100 | 93 | 38 | 57 | 65 | 71 | 74 |
| | tool side | 100 | 105 | 43 | 64 | 73 | 80 | 84 |
| 10 | master side | 100 | 94 | 38 | 57 | 65 | 72 | 75 |
| | tool side | 100 | 104 | 42 | 63 | 73 | 79 | 83 |
| 12 | master side | 100 | 93 | 38 | 57 | 65 | 71 | 75 |
| | tool side | 100 | 105 | 43 | 64 | 73 | 80 | 84 |

Consideration of the results of Table 1 shows that Inventive Examples 1 to 5 each exhibited reduction in surface pressure between the ball member and the inner surface of the ball receiving groove in contrast to Comparative Example 1, smaller radii r1 of the ball receiving groove provide larger degrees of surface pressure reduction, and the groove surface of r1=r+0.05 mm as in Inventive Example 1 exhibited the smallest surface pressure. In the case of r1=2.00r as in Inventive Example 5, the surface pressure reduces down to 84%. Particularly, r1=1.50r as in Inventive Example 3 is practically preferable.

Table 2 shows measurement results of rate of increase in pressing load on the ball member when the surface pressures of the grooves in Inventive Examples become equal to those in Comparative Example 1 through reverse operation from the surface pressures in Table 1.

TABLE 2

| | |
|---|---|
| Rate of load | Inventive Example |

| Ball radius | increase | 2 | 3 | 4 | 5 |
|---|---|---|---|---|---|
| r (mm) | (%) | 1.25r | 1.50r | 1.75r | 2.00r |
| 5.5 | master side | 571 | 381 | 291 | 252 |
| | tool side | 377 | 251 | 192 | 167 |
| 6.35 | master side | 559 | 375 | 287 | 249 |
| | tool side | 377 | 253 | 193 | 167 |
| 7.5 | master side | 545 | 366 | 280 | 243 |
| | tool side | 381 | 256 | 196 | 169 |
| 10 | master side | 531 | 357 | 272 | 235 |
| | tool side | 391 | 262 | 201 | 174 |
| 12 | master side | 538 | 361 | 277 | 239 |
| | tool side | 382 | 256 | 197 | 170 |

Reference to Table 2 shows that where the radius r1 of each of the ball receiving grooves 29 and 63 is 1.5 times larger than the radius r of the ball member 44 (r1=1.5r), this makes it possible to push (place load on) the ball member 44 with a force of approximately 250% with respect to that of Comparative Example 1.

Furthermore, measurement was made in terms of rate of reduction of radius r of the ball member 44 when the surface pressure of the ball member 44 in contact with the ball receiving grooves 29 and 63 becomes equal to that in Comparative Example 1. The results shown in Table 3 was obtained.

TABLE 3

| | | | | Inventive Example | | | |
|---|---|---|---|---|---|---|---|
| Rate of reduction of | | | Comparative | 2 | 3 | 4 | 5 |
| ball radius | | | Example 1 | 1.25r | 1.50r | 1.75r | 2.00r |
| 1 | master | ball diameter | 11 | 4.62 | 5.64 | 6.44 | 6.92 |
| | side | (mm) rate (%) | 100 | 42.0 | 51.3 | 58.5 | 62.9 |
| | tool | ball diameter | 11 | 5.68 | 6.94 | 7.94 | 8.53 |
| | side | (mm) rate (%) | 100 | 51.6 | 63.1 | 72.2 | 77.5 |
| 2 | master | ball diameter | 12.7 | 5.36 | 6.57 | 7.51 | 8.06 |
| | side | (mm) rate (%) | 100 | 42.2 | 51.7 | 59.1 | 63.5 |
| | tool | ball diameter | 12.7 | 6.54 | 8.00 | 9.14 | 9.82 |
| | side | (mm) rate (%) | 100 | 51.5 | 63.0 | 72.0 | 77.3 |
| 3 | master | ball diameter | 15 | 6.42 | 7.85 | 8.96 | 9.65 |
| | side | (mm) rate (%) | 100 | 42.8 | 52.3 | 59.7 | 64.3 |
| | tool | ball diameter | 15 | 7.68 | 9.38 | 10.74 | 11.54 |
| | side | (mm) rate (%) | 100 | 51.2 | 62.5 | 71.6 | 76.9 |
| 4 | master | ball diameter | 20 | 8.68 | 10.60 | 12.12 | 13.04 |
| | side | (mm) rate (%) | 100 | 43.4 | 53.0 | 60.6 | 65.2 |
| | tool | ball diameter | 20 | 10.10 | 12.34 | 14.12 | 15.16 |
| | side | (mm) rate (%) | 100 | 50.5 | 61.7 | 70.6 | 75.8 |
| 5 | master | ball diameter | 24 | 10.34 | 12.62 | 14.45 | 15.50 |
| | side | (mm) rate (%) | 100 | 43.1 | 52.6 | 60.2 | 64.6 |
| | tool | ball diameter | 24 | 12.26 | 14.98 | 17.11 | 18.41 |
| | side | (mm) rate (%) | 100 | 51.1 | 62.4 | 71.3 | 76.7 |

Reference to Table 3 shows that where the radius r1 of each of the ball receiving grooves 29 and 63 is 1.5 times larger than the radius r of the ball member 44 (r1=1.5r), this makes it possible to use a ball member 44 with a smaller diameter of approximately 65% with respect to that of Comparative Example 1 when the surface pressure is the same as in Comparative Example 1.

As can be seen from the above results, according to the technique of the present invention, thinning of the robot arm coupling apparatus can be effectively achieved.

### INDUSTRIAL APPLICABILITY

The present invention has a high industrial applicability in that thinning of the robot arm coupling apparatus can be promoted using ball members.

1. A robot arm coupling apparatus comprising: a master plate attached to a robot arm; a tool plate to which a tool or like element is attachable; and a locking device for joining and locking both the plates together, said locking device including: a cam member supported to the master plate slidably between a locking position and an unlocking position; a plurality of ball members arranged around the cam member and supported to the master plate for movement substantially orthogonal to a sliding direction of the cam member; and
a ball retainer disposed at the tool plate and engageable with the ball members to hold both the plates connected to each other when the cam member moves to the locking position, wherein
the cam member has a plurality of master side ball receiving grooves of substantially arcuate cross section formed to extend substantially along the sliding direction of the cam member and each capable of receiving one corresponding said ball member, said master side ball receiving grooves being spaced in the circumferential direction of the cam member in correspondence with the positions of the ball members,
the ball retainer has a plurality of tool side ball receiving grooves of substantially arcuate cross section formed to extend substantially along the sliding direction of the cam member and each capable of receiving one corresponding said ball member, said tool side ball receiving grooves being spaced in the circumferential direction of the ball retainer in correspondence with the positions of the ball members,
an inner surface of each said master side ball receiving groove is formed with a master side first inclined portion whose cross section taken lengthwise of the groove has a shape inclined in a specified direction with respect to the sliding direction of the cam member,
an inner surface of each said tool side ball receiving groove is formed with a tool side inclined portion whose cross section taken lengthwise of the groove has a shape inclined opposite to the direction of inclination of the master side first inclined portion, and
the robot arm coupling apparatus is configured so that when the cam member is positioned in the locking position, each said master side first inclined portion pushes one corresponding said ball member against one corresponding said tool side inclined portion.

2. The robot arm coupling apparatus of claim 1, wherein the inner surface of each said master side ball receiving groove has a straight portion located closer to the locking position of the cam member than the master side first inclined portion and joined to the master side first inclined portion, the cross section of said straight portion taken lengthwise of the groove being parallel to the sliding direction of the cam member.

3. The robot arm coupling apparatus of claim 2, wherein
the inner surface of each said master side ball receiving groove is formed with a master side second inclined portion located closer to the locking position of the cam member than the straight portion, the cross section of said master side second inclined portion taken lengthwise of the groove being inclined in the same direction as the direction of inclination of the master side first inclined portion, and
the straight portion and the master side second inclined portion continue through an arcuate portion whose cross section taken lengthwise of the groove is arcuate.

4. The robot arm coupling apparatus of claim 2, wherein the inner surface of each said master side ball receiving groove has an arcuate portion located closer to the locking position of the cam member than the straight portion and joined to the straight portion, the cross section of said arcuate portion taken lengthwise of the groove being inclined substantially in the same direction as the direction of inclination of the master side first inclined portion.

5. The robot arm coupling apparatus of claim 1, wherein a radius of each said master side ball receiving groove and/or each said tool side ball receiving groove ranges from 0.05 mm larger to twice larger than the radius of each said ball member.

6. The robot arm coupling apparatus of claim 1, wherein a radius of each said master side ball receiving groove and/or each said tool side ball receiving groove ranges from 0.05 mm larger to 1.5 times larger than the radius of each said ball member.

7. The robot arm coupling apparatus of claim 1, further comprising a rotation stop mechanism for inhibiting the cam member from rotating relative to the master plate about an axis along the sliding direction of the cam member.

8. The robot arm coupling apparatus of claim 1, wherein the master plate comprises a master body to be attached to the robot arm by a first fastening member and a cylinder head fixed to the master body by a second fastening member different from the first fastening member and having a ball accommodation part for accommodating the ball members.

9. A master plate for a robot arm coupling apparatus, said master plate being attached to a robot arm and connectable to a tool plate including a ball retainer, wherein
the ball retainer is formed with a plurality of tool side ball receiving grooves of substantially arcuate cross section, the inner surface of each said tool side ball receiving groove having a tool side inclined portion whose cross section taken lengthwise of the groove has a shape inclined in a specified direction,
the master plate comprises:
a cam member slidable between a locking position and an unlocking position; and
a plurality of ball members arranged around the cam member for movement substantially orthogonal to a sliding direction of the cam member, said ball members being configured, upon movement of the cam member to the locking position, to come into contact with the corresponding tool side inclined portions of the ball retainer and hold the tool plate connected to the master plate,
the cam member has a plurality of master side ball receiving grooves of substantially arcuate cross section formed to extend substantially along the sliding direction of the cam member and each capable of receiving one corresponding said ball member, said master side ball receiving grooves being spaced in the circumferential direction of the cam member in correspondence with the positions of the ball members, and
a inner surface of each said master side ball receiving groove is formed with a master side inclined portion whose cross section taken lengthwise of the groove has a shape inclined opposite to the direction of inclination of the tool side inclined portion, said master side inclined portion pushing one corresponding said ball member against one corresponding said tool side inclined portion when the cam member is positioned in the locking position.

10. A tool plate for a robot arm coupling apparatus, said tool plate being connectable to a master plate including: a cam member slidable between a locking position and an unlocking position and having a plurality of master side ball receiving grooves of substantially arcuate cross section each having an inner surface formed with a master side inclined portion whose cross section taken lengthwise of the groove has a shape inclined in a specified direction; and a plurality of ball members arranged in the master plate around the cam member for movement substantially orthogonal to a sliding direction of the cam member, said plurality of ball members being configured, upon movement of the cam member to the locking position, to be pushed and moved by the corresponding master side inclined portions, wherein
a ball retainer is provided which has a plurality of tool side ball receiving grooves of substantially arcuate cross section each having an inner surface formed with a tool side inclined portion whose cross section taken lengthwise of the groove has a shape inclined opposite to the direction of inclination of the master side inclined portion, said toll side inclined portion being capable of contact with one corresponding said ball member of the master plate, and
the tool plate is configured, upon movement of the cam member to the locking position, to be held connected to the master plate by bringing the ball members moving under the pushing of the master side inclined portions into contact with the corresponding tool side inclined portions of the ball retainer.

11. The robot arm coupling apparatus of claim 1 used for a robot for handling a work to move it from one pressing machine to another in a pressing process on a vehicle production line.

12. A vehicle manufacturing method comprising using the robot arm coupling apparatus of claim 1 to handle a work to move it from one pressing machine to another in a pressing process on a vehicle production line.
